(19) United States
(12) Patent Application Publication
(10) Pub. No.: US 2013/0263226 A1
(43) Pub. Date: Oct. 3, 2013

(54) False Banking, Credit Card, and Ecommerce System

(71) Applicant: Frank W. Sudia, Hagerstown, MD (US)

(72) Inventor: Frank W. Sudia, Hagerstown, MD (US)

(21) Appl. No.: 13/747,368

(22) Filed: Jan. 22, 2013

Related U.S. Application Data
(60) Provisional application No. 61/589,376, filed on Jan. 22, 2012.

(51) Int. Cl. H04L 29/06; G06F 21/60

(52) U.S. Cl. CPC H04L 63/08; G06F 21/60
USPC 726/4; 726/7; 726/27

(57) ABSTRACT

A false banking, credit card, and ecommerce system provides a family of inter-related computer software programs and processes that can a) generate and distribute seemingly valid false credentials that are made available to be “stolen” by criminals, b) provide an assortment of seemingly valid websites, business servers, or ecommerce sites that will apparently accept the false credentials, and c) track each use and provide trace information for use by law enforcement to apprehend and prosecute cyber offenders.

### APPLICATION PRIORITY

This application claims priority from U.S. Provisional Patent Application No. 61/589,376 filed Jan. 22, 2012, which is hereby incorporated by reference in its entirety.

### FIELD OF THE INVENTION

This invention is directed to the field of computer and network security, and more particularly to a system of false bank websites, bank accounts, credit cards, shopping sites, billing and payment methods, and related systems and applications for detecting, tracing, tracking down, arresting, and prosecuting perpetrators of online fraud and other illegal online activity.

### OBJECTS OF THE INVENTION

The present invention defines a family of inter-related computer software programs and processes that can, among other things, a) generate and distribute seemingly valid false credentials, which are made available to be “stolen” by criminals, and b) provide an assortment of seemingly valid websites, business servers, or ecommerce sites that will apparently accept the false credentials, while tracking each use and providing trace information for use by law enforcement to apprehend and prosecute cyber offenders.

### BRIEF DESCRIPTION OF THE DRAWINGS

FIG. 1 is a distributed computer system diagram showing the entities, servers, and processes that interact in one embodiment of the false banking system.

FIG. 2 is a computer system diagram showing the status of a web database application before (A) and after (B), (C) the automated system cutover.

FIG. 3 is a directory listing for a typical commercial application program installed on a Microsoft® Windows personal computer, in this case common files in an “HP” directory used by other Hewlett-Packard® applications on the same computer, these being the type of files an attacker would usually ignore.

FIG. 4 is a directory listing of some simulated confidential user data files, in this case a directory of client files created for a fictional business client named AmalgaTronics, including a site security analysis and personnel security data, these being the kinds of files an attacker would often find interesting.

FIG. 5 is a process flow diagram depicting the process of converting a TRUE user directory and files into corresponding GHOST and DUMMY directory and files, upon first commencing to use the GFM system.

FIG. 6 is a process flow diagram depicting the process of normal use of the GHOST files by the user followed by saving and updating the GHOST and DUMMY directories.

### DEFINITIONS & ACRONYMS

Admin Rights A level of user privileges high enough to administer a computer system, including installation or alteration of software
ADOS Application Denial of Service, an attack that consists of interacting with a web server or other online application in an unusual manner designed to trigger long delays, thus denying service to other users.
Autorun A feature of a removable media pack, such as a USB drive or CD/DVD ROM disk, whereby upon insertion a certain program or program will run automatically on the subject machine.
BIOS Basic Input Output System. Very basic system level code that tells a computer how to boot up, and which can be rewritten to include malicious instructions.
Bot
   1. A captured computer under the control of a bot-herder
   2. Any autonomous process, such as one that executes an automated script. “They used a bot to perform click fraud.”
   3. Under the present invention, an automated process, e.g., to feed fake credentials and PII into criminal phishing websites.
Botnet A group of computers than have been taken over by a criminal gang using a specific remote access tool, and which can be used or rented out individually or together to perform criminal acts.
C&C Server Command and Control server, a central computer, which may be a compromised machine, used to control malware, where the malware first installs itself and then attempts to contact its C&C server for further detailed instructions.
Carder Website A website or online forum for resale of stolen credit card details and other PII data. A complete set of credit card details currently sells for $2-5 depending on the card issuer.
Cease & Desist A legal demand made to an Internet provider or domain registrar.
Click Fraud Improperly clicking on interne advertisements, pretending to be a normal viewer, on websites that you control, usually using robotic agents (bots), to generate false or inflated advertising revenue.
DDOS Distributed Denial of Service, a type of attack which consists of flooding a victim server with a large number of packets, generated and sent by an armada of captive bots, to disable it and deny services to legitimate users, or cover up other simultaneously occurring criminal activities.
Denial of Service Using a variety of methods to slow down or crash a web server or other online computer asset, often for purposes of extortion or making a political or social statement.
Directed Attack A cyber-attack directed to a specific target/victim or class of victims, usually seeking specific information. Requires more planning but nets a higher profit to the criminals.
DNS Server A server that resolves domain names, which can be falsified under some circumstances, to make valid URLs point to illegal websites.
Dropper A small file containing program code used to initially infect a computer, which then downloads a config file and installs other malware.
Dropsite A computer, usually a compromised legitimate machine, that is used either to host malcode for downloading by newly infected victims or as a waypoint for storing stolen data.
Exfiltrate The step of removing stolen data from a supposedly secure network.
Exploit A file or other data designed to trigger a software vulnerability, to run arbitrary code, escalate privileges, cause a denial of service, or the like
False Negative An outcome that fails to detect and report a (usually adverse) event, when in reality such event did in fact occur.
False Positive An outcome that purports to detect and report a (usually adverse) event but does so in error, when in reality there was no such event, or the event in question was not adverse.
FFIEC Federal Financial Institution Examination Council. A joint financial regulatory group responsible for setting and enforcing cyber security audit standards in the banking industry.
Honeypot A computer that is placed on the internet with minimal cyber security and possibly out of date software, and exposed to infection, spam or other attacks. Such computers tend to rapidly become infected, and are commonly used to collect samples of the latest malware.
Iframe An HTML statement that references other HTML code on another website to be included by reference. Often used in malvertising or compromised legitimate websites to transfer malcode from a dropsite to a new victim machine.
IPv6 Internet Protocol Version 6, a new internet addressing scheme that allows for an astronomical number of internet users and websites.
Keylogger A program or feature that captures and steals user keystrokes
Machine Unless the context requires otherwise, machine is a general term for a computer, especially a desktop computer or mobile device.
Malcode/Malware Malicious software and related tools and config files Malvertising Interned advertising that contains links or references to malicious code Mass Attack A non-specific cyber-attack directed to any vulnerable computer anywhere. Requires less planning and skill but yields less profit.
Out of Band (OOB) A method of notification that occurs outside the communications channel normally used by the system to which the notice refers.
Phishing The use of false emails, websites, voice mails, or SMS messages to induce users to input their credentials and PII, whereupon they may be stolen by cyber criminals
Phone Home An attempt by a malware program or a GPS tracking device to contact its command and control server.
PII Personally Identifying Information, includes user IDs, passwords, bank account numbers, addresses, etc. Extended definition below.
Privileged User A user with admin rights or root privileges, who can make major changes to the software and operating system on a computer.
RAT Remote Access Tool. A program that can control a remote computer.
Remote Access Tool A program that allows remote control of a computer.
SCADA Supervisory Control And Data Acquisition. A class of computer systems used to control industrial plants and other infrastructure.
Screenshot Recorder A program or feature that captures and steals digital images of the user's computer screen, especially those containing PII or other sensitive information.
Skimming Theft of credit or ATM card details by installing an attachment over the card slot of an ATM machine, or by a waiter or store clerk running a client's payment card through a private data recording device.
SMS Short message system, aka texting.
SMS Intercept A malware program that intercepts SMS messages, including SMS messages containing “out of band” confirmation codes for online transactions or funds transfers.
Social Engineering Tricking the user into doing something, such as revealing information or performing an action, by false or fraudulent means.
Spam Unwanted advertising. Can be delivered via email, SMS, voicemail, or web article comments, etc.
Trojan (Horse) A program that has both legitimate features as well as unknown criminal ones. More loosely, any surreptitious malware program with an extensive selection of remote attack features.
Typo-Squatting The practice of registering interne domain names that are deceptively similar to legitimate well known websites, but vary by one letter, so users can visit them by making a typographical error.
URL Universal Resource Locator, typically a website address.
Virus A program that can replicate itself by attaching itself to (or including itself inside) other programs or data files.
Vulnerability A security weakness in a computer system that can be exploited to perform unintended actions.
Webmail Email provided through a website, e.g. gmail.com
Worm A malicious program that replicates by looking for other nearby machines and running an exploit against them, which obtains enough privileges to install itself, and then seek other machines to infect.

### The Rise of Cyber Crime

The years since the inception of the Internet as a general vehicle of culture, banking, and commerce have seen a phenomenal growth of illegal and fraudulent activity. Computers belonging to companies, government organizations, and private citizens are relentlessly hacked and hijacked from their owners' control to steal computer services, create botnets, send spam emails, perform denial of service attacks, carry out further attacks, serve as dropsites for malcode or stolen data, act as phishing sites or false/evasive DNS servers, extort money, log keystrokes, steal bank account and credit card data, perform false and fraudulent transactions, and many more, limited only by the imagination and skills of the cyber criminals.

Numerous computer security systems and solutions have been proposed and deployed to combat these illegal and fraudulent activities, but with minimal effect, because most computer software contains innumerable known and unknown security flaws and vulnerabilities that can be exploited to gain control over the target computer and install a wide range of malware, which then carries out a wide range of criminal acts, including stealing personal information, user IDs, passwords, bank account numbers, credit card numbers, and the like.

### Cyber Attack Methods

A typical attack on a consumer or small business bank account involves infecting the user's personal computer with a banking trojan. The operational details of such trojan horse programs and how to implant them on a user PC are well known in the field of cyber security.

In a typical case, a criminal organization will generate a poisoned web advertisement, also known as malvertising, containing an iframe that points to a dropsite that delivers a malware kit. An iframe is an HTML statement included in a web page that allows content from another website to be quoted, or “incorporated by reference.” A dropsite is a server, often a legitimate server or PC that has been hijacked, which can deliver a malware payload, for example the “Blackhole Exploit Kit.”

The code contained in the iframe contains an exploit that takes advantage of some known or unknown vulnerability in the user's web browser, allowing it to download and install a dropper file. In some cases the dropper file is delivered in a packed form (wrapped with encryption), and javascript on the webpage is included to unpack and install it.

Once installed and running, the dropper process runs with the rights of the current user. If the current user has “sysadmins” rights, which is common on home PCs, the dropper proceeds by downloading a config text file containing further instructions, and then download and install potentially a wide range of other malware. If the current user does not have Admin rights, thus preventing installation of further mal-products, the dropper will often try to run a “privilege elevation” exploit to obtain such Admin (System or Root) access rights, and if it fails it may abandon attempts to infect the user's machine.

The range of malware installed by the dropper can include a remote access tool, a botnet client enabling long term remote control, a banking trojan (containing special capabilities to steal financial information), an email server for sending spam email messages, programs for carrying out denial of service attacks, a click fraud bot, and many others.

There are myriad avenues for installing malware on computers, including poisoning the machine's BIOS chip, including the malcode in an autorun process on a memory stick or CD/DVD disk, sending the user an email from an apparently trusted course containing a poisoned attachment. These and many other means known (and unknown) in the field of cyber security are available for infecting a machine and installing malware.

### Theft of Credentials

Once the malware is installed, the criminals will often install a keylogger to record all user keystrokes and activate the banking Trojan to attach itself to the user's web browser and wait for him to access a banking website. Once the user logs into their online banking, the banking Trojan will record the bank URL, collect the keystrokes for the user ID and password, record the bank account number, the account balances, and so on. At this point the criminals have a set of valid online banking credentials that can be sold, or utilized to perform unauthorized transfers from the account.

Another type of attack is to wait for the user to visit an online store or other ecommerce website. When the user inputs their credit card number, the installed malware collects the keystrokes. A complete credit card record includes the card number, expiration date, card verification number, and the user's full name and address and zip code. These can be used to perform unauthorized transactions, sold to others, or used generate counterfeit plastic credit cards for use in stores, containing recently stolen and still-valid information.

Yet another way to steal credentials and PII is by creating and promoting a phishing website, which closely resembles a valid website, however when the user attempts to log in, it steals his personal account information, possibly then redirecting him to the true website, which it has already logged him into using that information.

Not only banking or credit card credentials are desired. Criminal gangs and foreign powers services are also very interested in theft of confidential business, military, and diplomatic information and access to sensitive computer systems. In these cases the malware programs will be looking for logins to other websites and servers of interest, including email accounts, and for documents of interest that can be stolen and used or resold for a profit.

For example it is alleged that hackers associated with the government of China wish to hack into email accounts, including webmail accounts such as gmail.com, of overseas military personnel and dissidents, to monitor all military and political threats. Thus there have been ongoing phishing campaigns to obtain email credentials for exploitation.

### Countermeasures

As would be expected, dozens or possibly hundreds of policies, procedures, and computer software products and services have been developed to combat these malicious activities. However, the FFIEC recently listed malware as the top threat facing banks, indicating that the war on malware is far from won. Many experts have concluded that the criminals are winning.

In a recent Washington Post article (Jan. 11, 2012), a cyber-security expert from Booz Allen was quoted as saying that, with respect to the growth of anonymous payment systems overseas, which are poorly understood, the criminals have a 5-6 year head start on US law enforcement. This sentiment is typical in the cyber security industry.

Among the many countermeasures offered by a wide assortment of anti-virus and anti-malware products, some will attempt to install a keylogger that is “senior” to all other key loggers, which is then used to capture the user's real keystrokes and feed them to an application, such as the user's web browser, while feeding meaningless keystrokes to any “junior” keyloggers possibly installed after it.

A complete list of all actual or proposed countermeasures would be too long to include here. More are being developed all the time, and many are possibly undocumented features of various cyber security vendor offerings. However to these many cyber security counter measures we add the following.

### SUMMARY OF THE INVENTION

To further detect, prevent, and deter cybercrime, it will be useful to provide a wide assortment of false yet seemingly valid credentials, to be made available for theft, plus an array of seemingly valid websites and computer services where they may be used, in a seemingly valid manner, so that the further use of the stolen credentials can be tracked and traced back to aid in the apprehension and prosecution of cyber criminals.

As a further strategy, these false credentials and websites for their use can be widely proliferated, especially in the vast new world allowed by IPv6, making it more difficult for criminals to determine which websites are real versus fake.

### Distribution of False Credentials

False credentials can be placed into criminal hands by many means, which may be known now or in the future, including:

1. In an anti-malware program that installs a senior keylogger, rather than send meaningless data to the junior downstream (criminal) keyloggers, if any, instead send them keystrokes that contain false user IDs, passwords, bank URLs, and credit card details. Thus we can supply a feed of poisoned PII data to anti-malware vendors, who then download it to their users' PCs, feed it through to downstream keyloggers, and optionally provide us with details of where and when the transfer may have occurred.
2. On a honey pot machine that is known or anticipated to be infected with botnets or other malware, run a special program that attempts to login to various banking and other websites (real or false) using a script that feeds in false the credentials. Here we simply mimic ordinary user behavior, which is technically easier than feeding strokes to a secondary keylogger. Such a machine can login to banking sites all day, thus significantly polluting the criminals' supplies of banking and credit card data, and rendering all such data suspect, thereby impeding the underground economy.
3. On any phishing website or other phishing mechanism that is identified, either run a script program or simply manually enter the false credentials.

Illegal phishing websites are not difficult to find, for example on Craigslist.org, look for apartments offered far below market rents, i.e., deals that are too good to be true. These are almost invariably scams, and some of those lead to phishing ploys, e.g., for phony credit or criminal record checks, that seek to elicit PII. Also certain false emails will lead to phishing sites.

4. False carder websites can be created to sell the fake credentials, including credit card details, in bulk to unsuspecting criminals, which will also accept payment using the fake credit cards.
5. Fake credentials can be given to undercover police or cyber security agents, who can then pass them on either individually or in bulk to unsuspecting criminals. Such false credentials offered for covert resale could also consist of apparent dumps from “unreported breaches” of major websites, where we have manufactured thousands or millions of user account records that purport to be from authentic websites, or false clones, and which when tried actually work, on a fake copy of the supposed website.
6. When criminals or foreign opponents compromise a computer inside an organization, they often seek to gather and steal documents. Therefore when an infected computer is found, such as by an anti-malware detection system, one response can be to quarantine that computer, without disabling the malware, delete all real confidential documents, and replace them with fake ones fabricated to contain seemingly valid, but nonsense information, such as by taking real documents and replacing all names and numbers with random values, including unique code numbers, and of course a selection of fake PII.

That is, such poisoned documents can include lists of login IDs and passwords for a variety of personal and business systems, all of which are fake, and that allow access but trigger alternate processing, while an attempt is made to trace who is using them. As with feeding poisoned credentials into key loggers or phishing sites, including them in false documents to be stolen by information thieves is yet another distribution method.

7. Other types of fake computer login credentials we can generate and distribute include:
Linux admin root+pw
SSH login+pw
Etc.

Logins to other computer servers and applications, with cooperation of their owners:
Amazon.com
Google.com
Salesforce.com
Etc.

The local software which tracks and alerts for use of the fake credentials should have an option not to alert when they are input by someone standing physically in front of a local machine, since this could be a legitimate physical user setting up the fake system, and testing some IDs and passwords to see if they work correctly.

### Contents of the False Credentials

The nature and format of the false credentials utilized by the present invention will vary over time, depend on the context in which the information is intended to be “stolen” and used, and in the future may include other data, however for purposes of this discussion, personally identifiable information (or PII) can be considered to include such things as:

| | |
|---|---|
| System User ID | Nicknames or Aliases |
| Password | Home Address |
| Account Number | Mailing Address |
| PIN Number | Zip Code |
| Date of Birth | Driver License Number |
| Mother's Maiden Name | Passport Number |
| Social Security Number | Citizenship |
| Sex, Weight | Employer |
| Hair Color, Eye Color, etc. | Job Title |
| Real Name | Work Address |

It may also include other “security question” data such as:

| | |
|---|---|
| Previous addresses | Make of first car |
| Spouse or child names | Favorite Color |
| First Pet Name | And so on. |
| First School Attended | |
| Street You Grew Up On | |
| Best Friend Name | |

### Creation of False Websites

The present invention provides a plurality of false but seemingly valid websites (or false user accounts on genuine websites) at which cyber criminals may use the seemingly valid credentials they believe they have stolen, where such usage may be logged and tracked.

Following the lead of the internet miscreants who have created a plethora of meaningless finder and Q&A websites, which can make it almost impossible to find a legitimate hard content site, we propose to use algorithms to create a possibly vast number of such sites, where our seemingly valid credentials may be used. Thereby making it more difficult to discern which ones are false or valid.

[Preferably we will work with internet search engines such as Google, Yahoo and Bing to remove our fake sites from search results, to minimize the risk of legitimate users finding and attempting to use them. Of course the use of legitimate credentials, which have not been stolen, will not trigger any alerts, since they are simply not valid on the fake site.]

These may include all of the following as well as many new types of websites or internet services that may be offered in the future:

1. False Online Banks. These will require regulatory approval, however it is believed this will be readily forthcoming. The present invention is a legitimate anti-crime system, which should face little difficulty in getting approved, and requires no modification to any existing online banking or financial systems.
2. False credential processing on legitimate banking sites. The operations of a legitimate banking or financial website can be altered to branch to an alternate set of processes when fake credentials of the present invention are used to access the site. This also a permitted banking activity, albeit one that requires modifications to a bank's website.

Metaphorically, this can be thought of as “www.fake.citibank.com.” Of course the word fake would never be used, but from the standpoint of internal processing, we expect a participating bank would generate a separate set of accounts and processing routines, to handle the fake credentials of the present invention.

It is common for criminals to conduct web based phishing operations by employing typo-squatting, the use of slightly misspelled URLs. Here we can park our fake bank sites behind such slightly misspelled bank URLs, including bank URLs that have been seized pursuant to cease and desist orders issued by the legitimate banks, which will then give or lease them to use for our operations.

3. False online merchants. Where a set of credentials has been stolen that grants access to a particular website, that website can be fake, and we can generate vast numbers of these, including on demand, diminishing the value of all stolen online credentials.
4. False credential processing on legitimate ecommerce sites. A legitimate ecommerce website can also be altered to branch to alternate processing to handle fake credentials. Metaphorically, this can be thought of as “www.fake.amazon.com.” As with the banks, each participating merchant would generate a separate set of accounts and processing routines, to handle the fake credentials of the present invention.

These could include a) outright false users, whose PII may be fed to honeypots, where crooks may try to login to order merchandise to be billed to (fake) seemingly predefined credit cards on the false user account, or b) a “legitimate” user who may attempt to purchase goods or services using a fake credit card, triggering alternate processing.

Many ecommerce sites also invite a purchaser to input a set of checking account details, so these fake websites, or alternate processing on true websites, need not be limited to accepting stolen credit card numbers, since we can just as easily allow for the input of stolen bank account details as a form of payment.

5. False Porn Sites, or true porn sites with alternate processing for fake credentials. The options here are the same as for other ecommerce merchants, except that such sites might be expected to experience a higher usage of stolen credentials, and therefore possibly to be more likely to enroll in the cyber protective service enabled by the invention.
6. Fake Carder Sites. Of course we would offer websites offering seemingly stolen credit card and bank details, and those sites would accept our own fake credit cards as payment. We could generate many of these sites, where traditionally it is very difficult to trace back the true operators, with a goal of eventually making it difficult to determine which carder sites, if any, were genuine.

Algorithms could be used to monitor real criminal sites, and generate replicas that differ in various ways yet mimic typical observed behaviors of genuine criminal sites.

7. Fake Bot Rental Sites. This is similar to fake carder sites. Criminals who have captured large numbers of user computers, and hold them under their control for criminal purposes are often called bot-masters or bot-herders. To monetize their bot-nets, they rent them out to other criminals, e.g., to conduct spam mailings, click fraud, or denial of service attacks. For this purpose they provide bot-rental sites where with a credit card another criminal can rent the use of some number of bots for a given time period. [Renters often complain that the bots are unavailable when the users turn off their computers at night.]

Creating a fake bot rental site is tangential to the overall effort to create numerous fake websites that all appear to accept our fake credit card and bank account numbers. Yet it can be another way to a) trick criminals into thinking our fake card details are legitimate, and b) track and trace their use over time.

8. Fake Webmail Accounts. The creation of fake webmail accounts on a new webmail service could be done without limit. However, to create a host of fake webmail accounts, purporting to be those of reporters, government officials, military or intelligence analysts, or others attractive to foreign intelligence operations, on an existing webmail service would require cooperation of the operator, since setting up fake accounts would violate their terms of use, and if in done significant numbers would almost surely be detected.

However, given the huge negative publicity arising from the Asian attacks on gmail, it seems likely that such cooperation would be readily forthcoming, as long as the usage burdens remained minimal.

9. Fake Social Network Accounts. Likewise it is straightforward to create fake accounts on social network sites such as Facebook, Twitter or MySpace, possibly belonging to seemingly important personnel, for which fake credentials can be distributed by any of the means listed herein. These accounts can be populated with seemingly important postings or connections, which criminals can peruse on accessing them, while we work with the social network site's operators to trace and track the individuals using the stolen PII.

This makes much more sense than giving out the PII of real users, since a) no real users are affected by our operations, and b) we don't have to filter out false positives when the real user accesses their account, since all access (other than by our system administrators or bots operating from pre-specified IP addresses) is by definition unauthorized.

10. Fake “Dot-Mil” Servers. Any organization concerned about penetration by hostile intelligence services could a) create fake accounts on legitimate services, and b) create or fund the creation of numerous seemingly legitimate but fake servers, with all fake users.

As a further measure, it may be desirable to transfer the PII of real high value users to fake servers, in case someone who stole it may attempt to use it on the fake server, much as any criminal might try any stolen PII on a system related to the one for which it was intended, to see if the user had reused his ID and password. To allow stolen real credentials to work on a related (although fake) service can alert us to their theft.

The fake user accounts, on either fake or legitimate servers, or legitimate user accounts transferred to fake servers, can be populated with phony documents such as fake intelligence reports, communications with dissidents or intelligence assets (spies), news articles related to military or political affairs, copies of previously stolen diplomatic information (such as the US State Department cables stolen and released by Wikileaks), copies of new and true diplomatic information, or copies of algorithmically generated documents, where the general form and content of real high-value documents is replicated substituting most names of persons and countries with different ones, rendering them meaningless, but seemingly real on first impression.

### False Wire Transfers

Criminals seeking to exploit a bank account will have as a major objective to transfer money to themselves. Therefore our fake bank websites will be equipped with well designed, easy to operate, and minimally secured features to transfer money to other bank accounts or payees via wire transfers, ACH transfers, bill pay options, or transfer to other payment options (such as Paypal) now known or to be developed in the future. Two of the more obvious options to implement these include the following:

1. The wire transfer function is entirely fake, and although the criminal goes through the motions of initiating and confirming the transfer, with minimal security, receiving normal confirmation messages, nothing happens in reality, since the feature is not hooked up to the real wire transfer system.
2. The wire transfer function appears to work, and funds seem to be actually transferred to the destination bank account, except by pre-agreement with the real wire transfer systems and their bank participants, these transfers have been flagged as false, and the recipients cannot withdraw, or wire on, those funds without risking arrest and prosecution.

Setting up destination bank accounts to receive stolen funds can be relatively difficult, at least in the West, due to the “know your customer” rules. Therefore it can be assumed that criminals will make heavy use of one, assuming it will be closed down at some point, after they have more than recovered their costs. By providing yet another means to rapidly compromise such a destination account, perhaps before much money has gone through it, the present invention can help deter and prevent financial crime and money laundering.

3. Criminals sometimes will wire funds from a victim bank account to another compromised account they control, prior to wiring them on to some destination where they believe they can withdraw them. Thus under the present invention we will seek to provide an assortment of banks that may appear attractive for these types of multi-bank operations, including banks in jurisdictions that are known to have very lax standards for opening accounts and withdrawing funds.

For example, if some group of banks in very weakly regulated Central Asian nations are known to be friendly to criminals, we can a) open accounts at these banks and allow criminals to steal those account credentials, and believe they have access to those accounts for criminal activities, or b) we can create very similar looking banks, perhaps via typo squatting, and induce criminals to try to wire funds to those banks, mistakenly thinking they are friendly when actually they are controlled by US law enforcement.

This will require special permissions, and should be designed to emulate the relevant types of banking services and criminal operations now in use, or which may be devised in the future, in the respective languages of those banks and services, etc.

4. If criminals like to wire funds from one victim account to another victim account, say in another country, to cover their tracks, we can “help” them by creating fake banks (for which we allow online signup) all over the world. Then when they “capture” one account, and believe they are wiring money to it from another “captured” account, if the sender and receiver accts are both fake, we need not touch the real WT system and can just “internally wire” the nonexistent money to ourselves, in the currency of their choice, perhaps giving them very favorable rates on any requested currency conversion.

### False Credit Card Processing

The creation of fake PII and account details on an entirely fake bank website is a trivial matter, since the data can simply be entirely fake, and merely formatted to look real. The creation of fake details on a legitimate banking website requires cooperation of the host bank, and adherence to their standard account conventions, including any new conventions relating to the designation and alternate processing of fake account numbers and user IDs.

Likewise on an entirely fake server devoted to political or military affairs, it will be easy to generate an unlimited number of fake users and documents. The main issue will be to obtain a seemingly valid high-value URL, such as xxx.state.gov or yyy.nsa.mil. However, these can be readily obtained pursuant to a contract for delivery of cybersecurity services to the respective government agencies.

Credit cards are more difficult to falsify, and have them appear valid, since they need to be accepted by the central card processing organizations, subject to conventions for alternate processing.

As with other methods described above, there are at least two possible routes. Work with existing credit card processors to have them issue and “accept” our fake numbers, and when presented re-route them for alternate processing, or b) create an entirely new credit card issuing authority, which might be metaphorically called www.FakerCard.com, that acts as both an issuer and processor of credit card numbers.

The numbers it issues are then distributed by any of the means listed above, or others yet to be devised, such as by feeding them into criminally designed malware systems, to make it look like they have been stolen, and then track and trace their use as a means to apprehend, prosecute, and/or deter cyber criminals.

Since this new organization, mockingly called FakerCard, will have a public presence, it should have a seemingly normal name and issue some cards that actually work. However, criminals might soon catch on that most of its cards seem to be false, forcing us to gravitate more towards asking major credit card processors to issue fake numbers, which when presented trigger alternate processing. Care should be taken to “age” any recently used numbers in case the prior legitimate user accidentally reuses them, since this use would presumably be accidental and non-criminal, or at least not arising from any logged cyber theft.

### Alternate Processing

In a preferred embodiment when a criminal tests a stolen credit card number to see if it is still valid, such as by doing a currency type inquiry or possibly charging a small amount, it should seem to work, or return some innocuous code, so as not to immediately alert them that it is fake.

When used to purchase goods online from a large, cooperating merchant, the credit card authorization system should reply with a special code meaning “tell them it's approved, but don't ship anything, and send us their shipping address,” because this card was never valid to begin with, but was designed to be stolen and used by cyber criminals.

On a site that is delivering only digital goods, such as pornography or legitimate MP3 files, the site can go ahead and deliver some goods, provide us the shipping details, and we pay them a token amount for helping us fight cybercrime.

On our false carder sites, we can easily deliver them additional false credit card numbers.

When a genuine bank receives a login request from one of our false accounts, one way they can implement alternate processing is to simply redirect the request to another system, which we entirely operate. It's not unusual for large bank to have multiple online systems, often reflecting their previous acquisitions of prior banks in various states or regions. Thus rather than remaining on http://www2.bank.com, the session could be redirected to http://www5.bank.com, which we control, thus relieving them of all responsibility for creating or hosting fake accounts or performing alternate processing.

This could be termed a honey-bank. Like a honeypot server, it seems to be valid but is actually a trap to lure the criminals while we try to track them down. Our fake banks, being government approved and validly certified, should all display green bar SSL, the hallmark of online trust.

Much or all alternate processing for fake cards or account details as described herein can also be performed for known stolen cards or account details, however this can expose the original account holder to unknown risks. Hence the emphasis throughout has been on de novo false PII, where there is no identifiable individual who takes any risk of dealing with criminals or foreign adversaries.

### Geolocation Tracking of Illegal Purchases

One means often used to trace back an IP address is to send it to a geolocation service, which attempts to determine where the user is located. If there is a session in progress, it can be mirrored over to an analyst or program that further attempts to analyze where the attacker is located, possibly looking through any intermediate bots or proxies.

In another variation, when a criminal uses a fake card number to purchase physical goods, and the type of goods allows it, we can work with cooperating merchants to deliver physical goods that contain a GPS (or similar) tracking device, similar to Lo-Jack or other anti-theft systems. This saves us the effort of monitoring mail drops, and lets us track and trace the stolen goods after the criminal receives them.

Each such GPS homing device will have at least a unique device identification number, which can be linked to the original transaction number and its fake payment card, the place from which it was originally “stolen,” such as a police honeypot keystroke feeder or script that input the data into a phishing website, and any other intermediate use that may have occurred. All such information can be formatted into a report usable for arrest and prosecution of whoever is arrested for possessing the stolen goods.

When the tracking device (affixed inside the merchandise purchased with the fake card) “phones home” using either WiFi or the cellular grid, the police can go out and pick it up, along with whoever is in possession.

### Anticipated Cyber Criminal Responses

Initially it will be easier to implement free-standing fake banks, however the criminals will soon catch on, and likely limit themselves to dealing only with a specific white list of known good banks, so then we'll need to work more closely with real banks to integrate into their operations for alternate processing.

When we gain the ability to issue our own fake credit card numbers, if we do so through FakerCard (our captive fake processor) we can generate entirely fake PII.

At some point criminals will start checking to see whether the home and mailing addresses listed in our fake PII are deliverable, which they can do by issuing a query to a Postal Service database. Then it may be desirable to do various things to make the home and mailing addresses in our fake PII seem real, such as—
Obtain permission to use the addresses of real people,
Get the Postal Service to allow us to insert fake addresses in their database, where an inquiry to that address will trigger an alert, so we know that someone checked it, but still returns that it is valid.
Work with builders or developers to create entire fake buildings or fake sections of apartment complexes, which can be listed as deliverable, and the like.
For example, contract with a building owner to pretend that there is an entire floor, which does not in fact exist, e.g., the often-missing 13^{th} floor, and then work with the Postal Service to route all mail to such floor into a box we control.
Likewise in a large complex there could be an “invisible” building, such as Building 29A, which does not exist, and all mail directed to it is handled like the missing floor.

Building owners and managers, especially in economically depressed areas, might welcome the additional income such non-existent real estate could provide. Also in some cities, there are ample numbers of totally abandoned buildings. The postal database may list these addresses as “vacant,” but we may be able to request that they be recoded to a less revelatory status, perhaps by naming a designated organization to retrieve any mail delivered to them.

With fake “captured” accounts we can gather real-time statistics on criminal flows, from credential harvest, to account attack, to outbound wires—because we're behind every step of the process.

### Cyber Counter Attack

In addition to fake login data, which can draw criminals to honey-sites, fake user accounts can be spiked with documents or other files containing counter-malware, for example email received by the fake user could include poisoned attachments, which if the criminals or adversaries open it, we could compromise them back. This is a legal gray area, but could open doors into their operations, and we'd have many chances to try it.

### Putting It All Together

Many banks, corporations, and government agencies are extremely concerned about cyber-attacks, against themselves and their customers, and they tend to rely on a marketplace of cyber security vendors to provide them with software tools and services to fend off cyber-attacks.

A fake banking system could be profitable, by charging corporations, cyber security vendors or law enforcement agencies $X per set of phony credentials issued, and then charging other fees for reports on how those credentials are used by crooks. Or maybe it could be a flat $X per set of credentials per Y months for issuance and reports.

Clients, which can include cyber security vendors, as well as police and law enforcement or intelligence organizations, would purchase a service that includes:
a supply of fake credentials having desired characteristics,
various types of software or scripts for feeding them into malware keyloggers or phishing websites, or any other known or future means of making them available for apparent theft,
reports on when and where the credentials were “stolen,” to be obtained from the aforementioned software, which knows it has fed a set of credentials into a criminally controlled system, and where and when that feeding occurred,
reports on further testing and use of the stolen credentials, including the IP address and time of each use, and any other information that may have been supplied by the criminal(s) in a transaction, that was not part of the original fake information, such as shipping address, delivery telephone number, size, color, etc.

The central fake credential service will provide, either acting alone or in cooperation with other legitimate organizations:

For any login information, a “honey” server or computer system that can accept such login as seemingly valid, and provide access to seemingly valid account services of an apparent legitimate user/victim, such as emails, documents, banking services, gaming access, etc. For any fake credit card number and associated personal data, a back end process that can accept such PII and perform a seemingly valid transaction, including responding positively to standard tests of validity, providing seemingly valid online and emailed confirmations, and possibly even shipping merchandise that has been optionally tagged with a radio or cellular beacon, to facilitate the arrest of whoever receives it.

For any online banking PII, a fully functioning banking website, which may be entirely fake, or a redirect from a legitimate bank, that can present seemingly valid bank account data, possibly with large available balances, and perform seemingly valid transactions (such as ACH or wire transfers) to seemingly transfer these imaginary funds elsewhere.

Where the to-account of the attempted ACH or wire transfer happens to be a fake account at the same fake bank, or at another fake bank that is part of the system, to seemingly transfer the imaginary funds to that other fake account.

Where the to-account is not part of the fake banking system, and appears to be a real account at a real bank, to provide that to-account information to law enforcement or other authorized personnel of the client.

In the foregoing case, when authorized and reimbursed by the client, to perform a real funds transfer to the criminal to-account, if the amount is affordable and there is a reasonable chance that the recipient can be apprehended.

### Operational Narrative

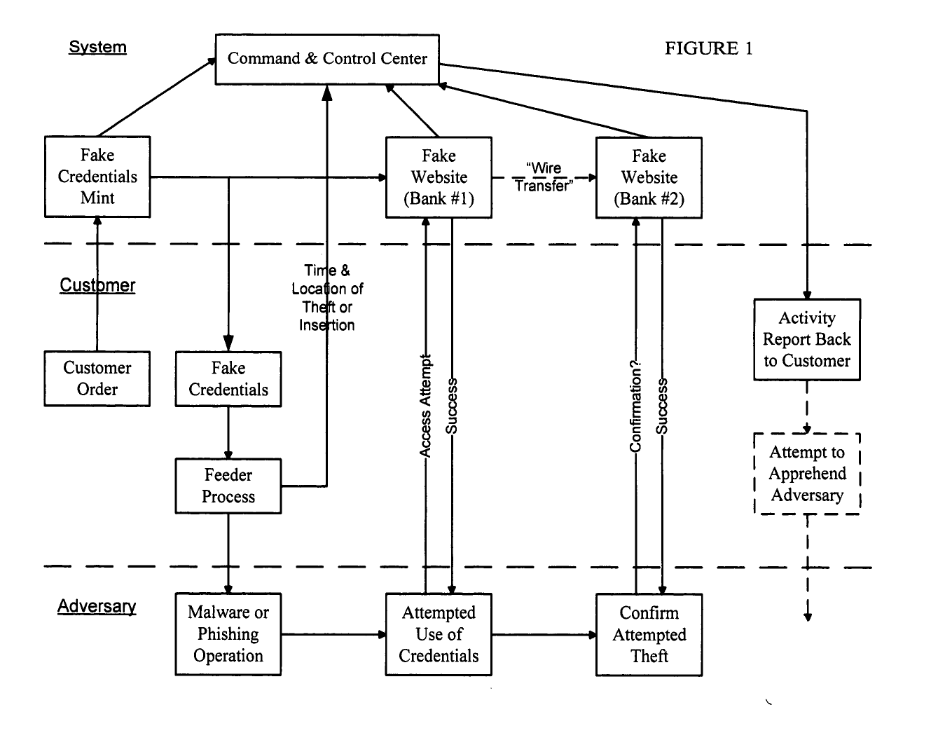

As seen in FIG. 1, a customer requests a batch of fake credentials, which are generated by a credentials mint and sent back to the requesting customer. A report of the sale is passed to the C&C Center, and the credentials are forwarded to one or more pre-agreed fake websites where they will be valid. A client-side feeder process passes the fake credentials to a criminal malware or phishing operation, which later sells or attempts to use them. Upon accessing Bank #1 they see a seemingly active bank account with large balances. In one scenario, where they believe they have captured an account at another bank, which is also fake and under system control, they may attempt to wire funds from Bank #1 to Bank #2. This transfer also succeeds, which they verify by logging into Bank #2. The C&C Center sends a report of all criminal activity using a given set or sets of credentials back to the requesting customer, which may use the information to contact law enforcement and attempt to apprehend the would-be cyber thieves.

### Further Enhancements

The feeder process, which will feed the fake credentials to a criminal operation which believes it has stolen them, can also operate in a setup mode, whereby the legitimate users, who have purchased the fake credentials can perform incidental tests to verify that the credentials work.

This can be implemented by providing a second password, not to be passed to attackers, which will grant access to the fake accounts.

To minimize the ability of cyber criminals to automatically validate the possible falseness of the stolen credentials, the DNS and IP address records to which they resolve should preferably be in the name of actual or fictitious banks.

### Other Fake Online Services

Beyond the banking and payment system, and civilian and military computer usage, lies the still uncharted realm of industrial infrastructure, such as power plants, power grids, water systems, railroads, bridges, subway systems, chemical plants, oil refineries, orbiting satellites, and many others, many of which are controlled by SCADA systems, that can be vulnerable to cyber-attack.

To further defend these systems, and to prevent, deter, and prosecute unlawful and unauthorized access to these critical systems, a similar set of strategies can be employed. In this case, rather than logins to online banking systems, or credit card details that can be used to make unauthorized purchases, the attackers are seeking access to these SCADA systems, for purposes of sabotage, industrial espionage, extortion, or cyber war.

Accordingly, under the system of the present invention, we provide a supply of fake logins to process control networks and associated systems, including fake servers for plant and process control. Then whenever a cyber-attack is detected that is attempting to steal such credentials, we provide a class of software tools to feed such fake credentials to such criminal attack software, to make it seem like the criminals obtained valid data.

To further back up these fake credentials, we also provide a network of multiple fake SCADA and other industrial control servers, so that when attackers attempt to use the credentials they have stolen, they appear to work, granting access to what seems like the control panels of critical systems. However, such control systems are fake, do not actually control anything, and instead the attackers are drawn into a “honey” server to provide time to trace back and track down the perpetrators.

Here the advantage we have over the attackers is that whenever a set of de novo fake login credentials is used, we know immediately that whoever uses them is an attacker, and we direct them to fake but attractive looking resources, which divert their attention while we attempt to learn who and where they are.

Eventually, if there were (say) 10 times more fake sites than real ones, and the login credentials to the fake sites were being regularly fed into the malware they use to steal such credentials, attackers would be deterred, because only 1 in 10 such sets of stolen credentials is actually valid, but their usage can lead to detection and arrest or other countermeasures (such as possibly drone attacks).

Here we assume that their cyber-attack methods will continue to work, and they will continue to obtain other valid credentials to valid systems by successfully attacking valid users. However, in many cases we may be able to detect their attacks, but rather than squelch them, we'll feed them fake credentials, and then track their activities when they attempt to use them.

This mode of operation is already implicit in cyber security software solutions that trap the user's real keystrokes and feed phony keystrokes to other keyloggers that might have been installed up the line. If the phony keystrokes are replaced by fake login data, then an additional layer of deterrence and counter surveillance has been provided, without our needing to explicitly know whether or when the machine was compromised. The same fake credentials can be fed in again and again, for a given machine to be protected, since that would be normal user behavior, thus economizing the consumption of fake logins.

In addition to fake industrial plant control systems, we can provide fake orbiting satellites, which in reality are access control systems located on real satellites, which respond to attempts to access them using fake credentials, initiate alternate processing, and then entertain their attackers with fake parameter readouts and fake buttons that could crash the satellite, while operations are conducted to determine the source of the attack.

The fake satellite access codes would be distributed through malware feeding systems, and embedded in false documents, at locations where cyber-attacks seeking to obtain such codes are expected.

Such methods can be generalized to any military system, including missile launchers, drone control systems, and the like. That is, we can feed fake drone access codes to actual or invisible malware, and then further provide a subsystem on the drone that appears to respond to the codes, but then, for example, seems to harmlessly malfunction somehow (as alternate processing) before any real damage is done.

### Automated System Cutovers

In another embodiment, where we suspect that adversaries have already compromised a military or other critical system, but are accessing it in minimal ways to avoid detection, such system could be replaced via being cut-over to an entirely new system, and the previous compromised system could become the fake system, with all legitimate users being issued new login data valid only for the new system. At that point, any use of the old system, by stealthy lay-low attackers will trigger an alert, since no legitimate user is accessing it anymore. In place of the old system, a new upgraded but fake system may be provided, to further entertain the attackers until they can be traced.

To accomplish this latter feat, we provide a software process whereby, to create the new fake system, we monitor the use of the old system by a legitimate user, capture a selection of its screens, menus, and their associated data, and then analyze those to synthesize a similar looking fake system, which need have little or none of the real underlying processing, but generates a set of screens that resemble the original ones, strongly enough to fool an attacker for a moderate period of time, especially one who is using read only behavior and not seeking to make himself known by performing any actions.

Such a process analyzes the screens for obvious tropes, including menus and fixed framing versus varying data fields. Then for the fake version it generates code that reproduces the menus and fixed framing, but allows the variable data to change as the attacker scrolls through the screens, while generating semi plausible test data, possibly by taking real data and altering it via substitution of similar words and numeric values, e.g., proper names, place names, dollar amounts, dates and times, pressure readings, etc.

By such means we can quickly and cheaply generate a fake system to replicate a critical system we believe may have been compromised, cut the current system over to a new web address with all new user IDs and passwords, yet allow long term stealthy attackers continued access to the fake system, so we can track them when they attempt to login.

An even simpler way to trap and trace long-term stealthy attackers is to cut the system over to a new web address, replace all user IDs and passwords, while leaving the login page of the prior system just as it was. Then when the attackers come back with their stolen credentials, the login page seemingly grants access, lets them change their password, and possibly even grants access to the old system (if it is still running), like before, but with much more limited rights, such as removing most of the access rights of the former ID, and possibly directing it to areas containing mainly fake data, which has been generated for this purpose

If the foregoing login page substitution maneuver were performed on a regular basis, it should both detect and deter long-term stealthy attackers. Accordingly, an application development framework is provided that automates the foregoing process.

On a command of the legitimate system administrators, the system will reconfigure itself as follows. First it sends a notice of system change-over to physical paper mail addresses of the legitimate users. This notice will not be received by the remote attackers. The notice will contain the new URL and preferably new name of the online service, while the old login page will remain available as before. The legitimate users will be instructed to access the new login page and change their passwords. All old user IDs and passwords will be maintained on file so that when the attackers log back in, their stolen passwords will still work. Then when the stealthy attackers access the old system, it will look and act much like before, their IDs and passwords will still be valid, but their session will be redirected into alternate processing, such as being shown fake data, and having their access rights reduced, while an alert is sent to security personnel and law enforcement, who can undertake to trace them (using then known methods) while they remain online.

Although somewhat burdensome to the legitimate users, who are required to change their passwords on demand, this method imposes very little burden on them, nor does it require significant recoding of the application, other than the first time, when the alternate processing and fake data regions need to be provided. For newly developed software applications, such cutover and alternate processing capability will already be built in, so the admins can cut the system over to all new passwords, at an all new URL, at any time. This push-button cutover functionality can be incorporated into standard software development frameworks for secure systems development.

Where a legitimate user has failed to receive or act on the out of band cut over message, but is apparently logging in from a previously known office or home location, he can again be sent an out of band message, such as a phone call, reminding him or her to perform the cut over process, without generating a false positive. If their access continues after the second out of band notice, they are an attacker.

The programming needed to provide alternate processing in a typical database application could be relatively minimal, if the fake data is contained in an alternative database with a structure that is identical to the legitimate one. Thus if the alternate process accesses this alternate database, all its table names and data fields will be in the same format, causing the application to work the same way as before, only with alternate/fake data. This imposes a burden on systems developers and maintainers to make all format changes in both copies of the database, so that the alternate process will not crash when it encounters a missing data field. However, a set of utilities or IDE features can be provided that remind the developers to make these changes, or make them automatically, likewise rerunning any process used to populate such new data fields with fake data.

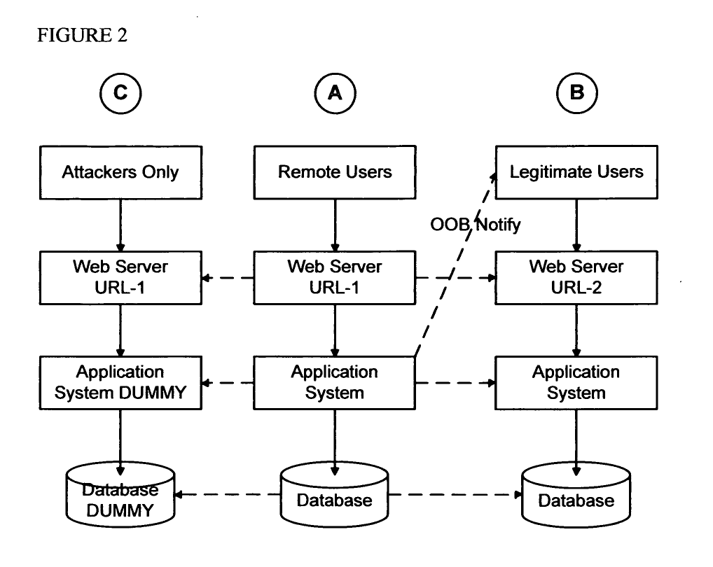

FIG. 2 is a system layout diagram showing the objects and processes of the automated cutover cyber security system. Column A shows the typical layout of an online web based application. Remote users access a web server using a given URL. This web server in turn passes their requests to an application system, which processes them and updated is database. All of this is well known in the art of computer systems design. At a given point in time, the system generates and sends an out-of-band (OOB) notification to its legitimate users. This OOB notice will generally not reach any or all remote attackers who are accessing the system using stolen credentials. Then the system operators will cutover to the system of Column B, which uses the same application system and database, but a different website URL. Meanwhile the original website will be left in operation at its original URL, preferably with a dummy application and database, to provide the impression the system is still operational. All further access to the old website can now be considered as being from suspected attackers.

### Ghost File Management System [not in Provisional Application]

In attempting to protect valuable intellectual property or strategic communications companies, government agencies, and individuals face difficult problems. It is onerous to perform research without accessing the Internet, yet most forms of Internet access, including email, web searching, viewing online ads, or downloading PDF files entail a risk of receiving malware, which may infect a computer with the intent of stealing intellectual property, financial information, or other confidential data. Often researchers or analysts will be victims of targeted attacks, in which personalized fake messages are sent to specific individuals containing customized malware that uses heretofore unknown vulnerabilities (also known as zero-day) to achieve infection, and evades detection by all known means of virus scanning and the like. Once the infection succeeds, the attackers take full control of the victim's computer, download additional malware, attempt to infect other computers on the same network, steal files or data on the subject machine, trap keystrokes, take screenshots, bypass encryption systems, implant false information, use the machine as a staging ground for stolen data, further attacks, and more. The malicious art of infecting machines, taking control of them, and using them improperly or stealing the information they contain is well known in the field of computer security.

The well-informed computer user, knowing these facts yet still needing to interact with the Internet, is therefore advised to operate under the assumption that her computer may be under the control of unknown remote attackers. In the field of computer security the phrase “security though obscurity” has a bad reputation, since it is preferable to assume the attackers have the full source code of the system under attack, so that its security relies solely on its secure design and secret keying materials. This standard of review is commonly used in the field of cryptography. However, cryptography has proven insufficient or even worthless to protect against malware attacks, because the attackers commonly operate with the full privileges of the legitimate user, and hence can easily get around the cryptographic protection, simply by sniffing the user's passwords and activating the decryption system, as if they were the legitimate user. In a recent book cryptography expert Bruce Schneier admitted that excessive claims made for the security value of encryption systems had in fact made computers less secure, by creating a false sense of security and diverting resources from more promising areas of computer security research.

In the field of computer security it has long been recognized that no one type of security control system can be 100% effective in warding off all forms of attacks and computer misuse. Hence users and organizations are advised to practice layered security, in which a variety of information security systems are used in tandem, each of which may prevent certain types of attack, or render them less likely to succeed.

### OVERVIEW OF THE INVENTION

The system of the present invention creates a layer of obscurity in the file system of a subject computer, with the intention of fooling the remote attackers and foiling their attempts to steal valuable data. Once the attackers understood what was happening, they could overcome this defense mechanism and continue to steal data as before. However, in many cases, if its use was not known or understood, it may provide an additional layer of defense, potentially buying valuable time to detect and thwart the infection, and therefore is better than doing nothing and merely giving the attackers free rein.

Once attackers gain control of a computer, especially a high value computer containing confidential commercial or strategic data, they will typically try to steal such data by either browsing the user's directories looking for interesting data, or else retrieving all files having suffixes commonly used for user data files, including DOC, DOCX, XLS, XLSX, PDF, DBF, MDB, VSD, and many others. Such files may be moved to a central directory created by the attackers, compressed into one or more ZIP or RAR files, and then exfiltrated via file transfers to a remote site, such as in Russia, China, Iran, or elsewhere. Therefore we seek to a) conceal the true data files under innocuous and uninteresting looking names, and b) create a set of dummy files with the true names, but containing no usable data, for the remote attackers to steal.

Consider a system utility such as Microsoft® Windows File Manager, or the like. It provides a file-picker that allows the user to navigate around the tree structure of her computer's file system, perform searches, view directory structures and contents, and select individual files to be opened by a pre-assigned application. Thus for example files having the suffix “PDF” will be assigned to be opened by either Adobe® Acrobat, or another compatible application that can open and process such files. Windows File Manager displays the user's directories and files as they really are, which is how they will be viewed by the remote attacker. However, for files we wish to keep secret, we can create an alternate set of ghost directories and files with ghost names, and provide a Ghost File Manager that translates these ghost directory and file names to “real” ones usable by the human analyst. In this manner, the attackers will see false file names and directories, which are evasively named, whereas the true user, activating the Ghost File Manager, will see them as they really are, his valuable work and client files. In addition we can maintain old time stamps for the ghost directories, and also create what we will call dummy directories, that look like the true directories would have looked, including true timestamp information, and which seem to be encrypted, but in fact are filled with random data, which can never be decrypted because it was never real to begin with. Such dummy directories can further divert the attacker's attention and delay their attack.

The overall objective is to provide a simple file name and location obfuscation system that has little or no apparent overhead to the true user, while adding a layer of defense against attacks that gain full control over the user's machine.

### DEFINITIONS

For consistency the following arbitrary terms will be used when describing the directory and file structures of the present invention:
TRUE means the original true user files, which will exist on the subject computer at the beginning, but will be replaced by the GHOST and DUMMY directories and thereafter will no longer exist, as such.
GHOST means the concealed or camouflaged user directory and files, typically renamed and redated to look like (e.g.) mass market application program files, antivirus definition files, or others which should be uninteresting to attackers.
DUMMY means a decoy directory and files, which look like the original TRUE ones, but contain either garbage or specially created random data which looks as if the files had been encrypted, but will never be decryptable.
WORK means a directory to which the GHOST files will be temporarily copied and renamed back to their TRUE names, accessed normally by the true user, and moved back to their GHOST locations after use.

### DETAILED DESCRIPTION OF THE INVENTION

In one embodiment, the user installs the Ghost File Manager program of the present invention on their computer and activates it, bringing up a window that looks similar to Microsoft® File Manager, but instead is the Ghost File Manager, herein “GFM.” When the user navigates to their usual work directories, they see their unprotected files, and the program asks or provides an option to camouflage them. If the answer is yes, the program a) creates the GHOST directory, b) copies the TRUE files to a set of GHOST files with names automatically selected to resemble (e.g.) mass market program files, and c) replaces the TRUE files with compressible random data, which will thereafter be called the DUMMY directory and files.

Thereafter, when the user wishes to access their files, they navigate to the DUMMY directory, which looks like their TRUE data, but the GFM program d) returns their TRUE data to them from the GHOST location, e) allows the selected program to operate on it normally, and then after such access, it f) returns the TRUE data to the GHOST location while resetting its old timestamp, and g) updates the DUMMY directory with any changed file names, time stamps, and file lengths.

To evade detection by attackers, the DUMMY files should compress to a normal ratio for the type of file, when processed by file compression utilities, such as ZIP or RAR, which the attackers will use. They should not be filled with normal random data, which would fail to compress, but rather with special random data containing enough blanks and repetitive structures so that it will exhibit a normal compression ratio.

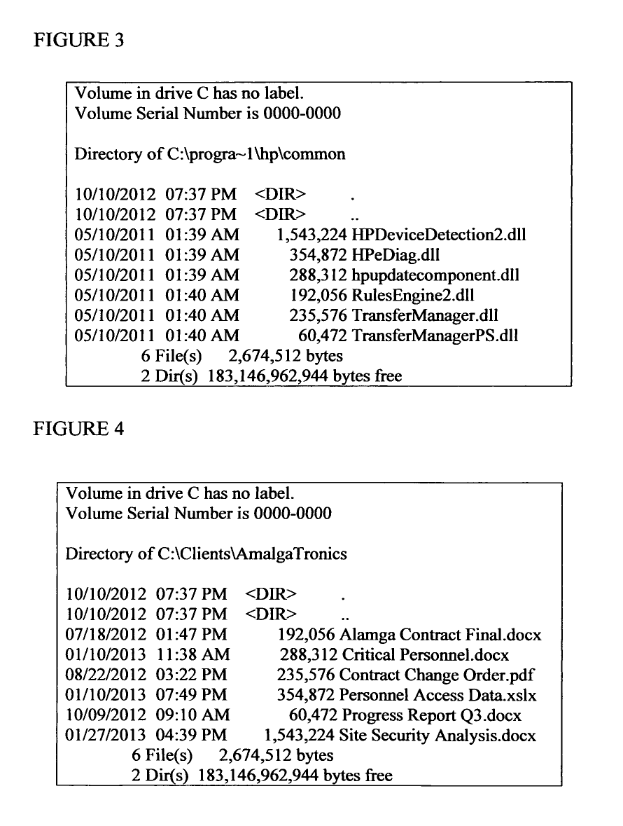

FIG. 3 provides an example file directory listing for data that an attacker would usually ignore. The file names look like program components, while the timestamps are old and mostly the identical date, long in the past, when the programs were installed.

FIG. 4 provides an example file directory listing for data that an attacker would likely find interesting enough to attempt to steal. The file names look like high value business or strategic documents, and the timestamps are recent and all different, falling within the normal daily work hours of the analyst.

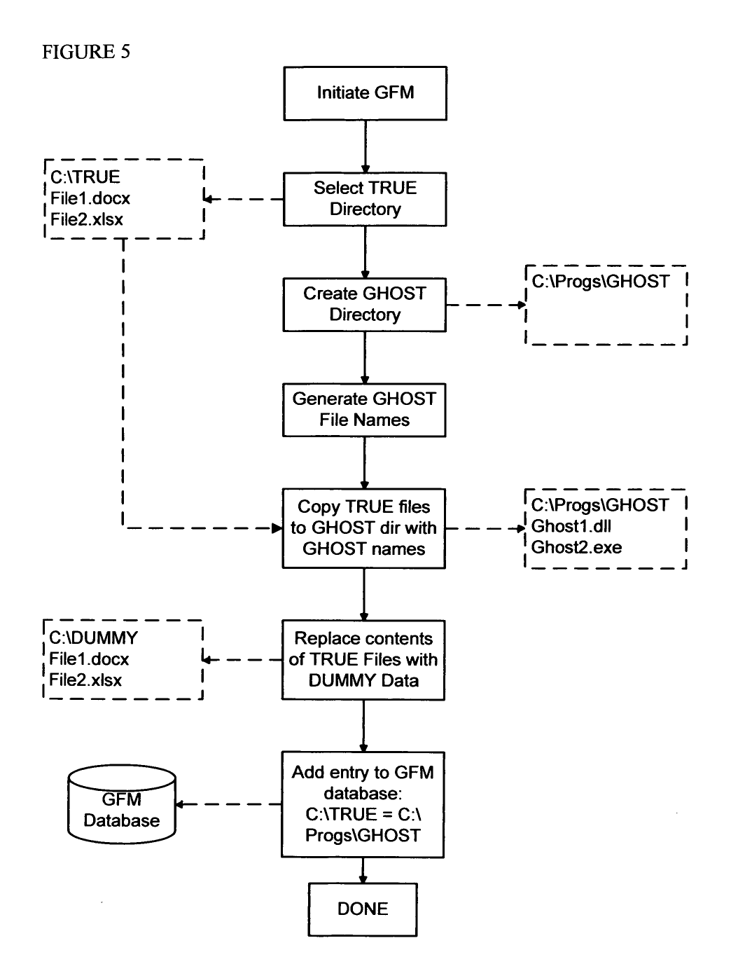

As shown in FIG. 5, the user installs and initiates the GFM program on their computer, selects a TRUE directory, and at the user's request creates a corresponding GHOST directory. A GHOST directory and file name generator, not shown, will be used to invent suitably uninteresting names and locations. Once it has enough GHOST names, the program copies the TRUE files to the GHOST location renaming them to their GHOST names and providing old, identical timestamps. Once the TRUE files have been successfully copied, the program overwrites the contents of the TRUE files with dummy data, such as random data that exhibits a compression ratio typical for files of that supposed type. The resulting DUMMY directory and files will appear to resemble the original TRUE data, but be useless to a remote attacker, and it will remain located in the original TRUE location. The system then makes an entry into its database equating the TRUE (and now DUMMY) location with the GHOST location, to aid future retrieval.

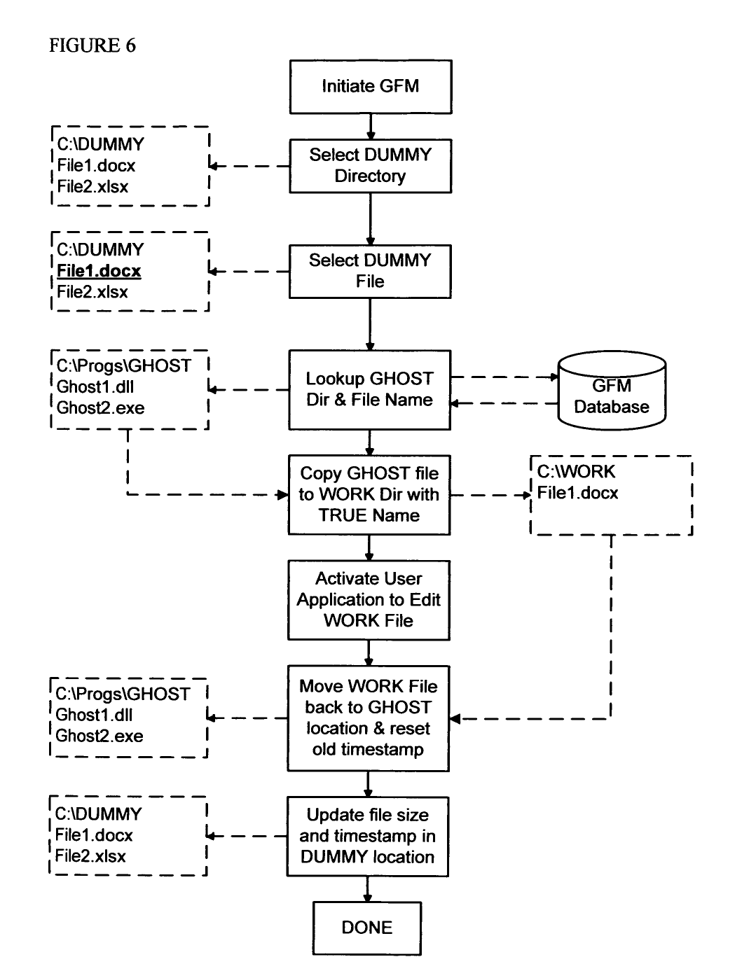

As shown in FIG. 6, to perform their normal work, the user initiates the GFM program on their computer and selects a DUMMY directory and file they wish to work on. The program looks up the GHOST directory and file location corresponding to that DUMMY location, copies the selected GHOST file to a WORK location, renames it to its TRUE name and invokes the normal user application program (e.g., Microsoft® Word) to edit the file. Upon completion of editing, the system moves the updated file back to the GHOST location and resets its old name and timestamp, updates the length of the DUMMY file, by adding or subtracting compressible pseudo data, and updates its timestamp.

Similar processes (not shown) will be provided to create new data files, rename existing data files, and delete old data files. Preferably at all times the user appears to be working in the DUMMY directory, which has the TRUE name and resides in the TRUE location. Therefore when she attempts to create a new file in the DUMMY location, such file will be first created in the WORK location, in plaintext, edited, and then suitable DUMMY and GHOST entries will be created for it. Likewise when a file is deleted or renamed, from what appears to be the DUMMY location, both the DUMMY file and its corresponding GHOST file will be deleted or renamed, and also removed from (or renamed in) the database.

### FURTHER EMBODIMENTS

The system can optionally encrypt the GHOST data files (i.e., the TRUE ones that have been disguised) however this is not advised since a) it makes the files harder to recover in case of any mishap, and b) if desired, such encryption is better left to specialized programs, as a separate layer of security, which will take further precautions to assure recoverability.

Rather than compressible random data, the DUMMY files can be filled with apparently readable but phony data that has been either taken from other documents and rendered useless, such as by replacing all names and dates, or generated fresh by a pseudo text generation program.

The DUMMY directory and its compressible dummy files could be eliminated and the GFM system can operate solely using the GHOST directories and files. However in this case a) the system requires a database file containing the real information, which could otherwise be obtained from the DUMMY directory, which serves the role of such a database file, and b) we will no longer provide the DUMMY or decoy directories and files, which had created an additional layer of defense, by making the attackers think they had stolen something.

In another embodiment the DUMMY files, especially ones containing pseudo data, which are a type of honeypot, may contain tracking information such as specially crafted URLs and/or (remote loading) clear GIF files, that when opened by the attackers will attempt to access a special tracking server, thus providing information on who stole them. Under the present invention the true user would never open the DUMMY files, or would do so only from their proper location, so any use of such files would by definition be unauthorized and should be tracked.

In further embodiments the GFM system can, a) upon request, convert an entire directory tree of TRUE files to DUMMY and GHOST directories and files, as a batch operation, b) obfuscate the DUMMY directory and file names by substituting pseudo names, in cases of extreme confidentiality, retaining the true names in a configuration or internal database file for display to the true user, c) encrypt the configuration or internal database file using a password or other standard encryption method, to prevent such file from being casually read by the attackers, and d) elicit such password from the true user when they commence using the program.

Rather than executable program files and associated configuration files, many other types of innocuous or “uninteresting” files are available on modern computers, including system updates, crash report files, system log files, system help files. In addition ghost files can be placed into subdirectories of legitimate program file directories, and so on.

Ghost files can also be migrated to remote, shared, or cloud directories, where they can optionally be scattered among vast quantities of dummy files. The GFM and its database can likewise be “ghosted” into an obscure location or be remotely located, so no true files or information about their locations exists locally.

To maintain innocuous looking timestamps in the ghost directory, that is, of a uniform stale date and time, it may be desirable to include a specially named ghost file, perhaps with the same name as the ghost directory, which is guaranteed to exist, such as GhostDir.exe. In this manner when the GFM goes to save a recently edited WORK file, it can easily determine the proper timestamp, by looking for this particular file.

A systems programmer skilled in the art of programming file system utilities can easily implement the system defined above, and many variations and enhancements thereof. The GFM system can be used in conjunction with many other security systems, including ones that encrypt the data, or populate the user's machine with large amounts of other pseudo data, to further confuse, delay, and mislead attackers, potentially buying time to foil their attacks.

The systems and methods of the foregoing inventions could be varied in many ways known to those skilled in the art of cyber security and computer systems design without departing from the spirit of the inventions.

I claim:

1. A method for deterring cyber attacks and for tracing and tracking cyber attackers comprising:
a. a source of seemingly legitimate but false online access credentials,
b. a means for inputting said credentials into criminal malware systems,
c. a means for accepting said credentials and granting apparent online access,
d. a means for reporting said access using said credentials to a user.

2. The method of claim 1 where the said credentials comprise a bank URL, user ID, and password.

3. The method of claim 1 where the said means of inputting is a cyber security system that feeds false keystrokes to a downstream keylogger.

4. The method of claim 1 where the means of accepting said credentials is an apparently valid (but false) online banking website.

5. The method of claim 1 where the means of accepting said credentials is a valid online banking website and wherein said website redirects the user to a separate apparently valid (but false) website for alternate processing and reporting.

6. The method of claim 1 where the means of accepting said credentials is a valid online banking website and wherein said website performs its own alternate processing and reporting.

7. The method of claim 1 further including a means for reporting said inputting to a user.

8. The method of claim 1 wherein said means of reporting said inputting or access via the false credentials to a user includes sending a feed of such data records to an IP address specified by said user.

9. A method of identifying low-activity remote cyber attackers of a computer system comprising the steps of:
a. migrating the subject system to a new URL,
b. creating a replica system with dummy data at the prior URL
b. notifying all legitimate system users of a new system URL via an out of band method,
d. maintaining the replica system at the prior URL, and
e. logging any further system access as potentially unauthorized,
wherein the method of designing and maintaining such subject system further comprises:
f. steps for creating the parallel replica system as part of the original system build,
g. steps for maintaining the dummy replica database as part of the standard system maintenance process,
h. incorporating an automated cutover process as part of the original delivered system, that performs steps a-e above, using the already existing replica system and database of steps f-g.

10. A method for concealing true user files on a computer system to potentially prevent data theft by remote attackers comprising the steps of:
a. identifying a true user directory to be camouflaged,
b. selecting a set of innocuous looking ghost directory and file names,
c. copying true user files to the ghost location using the ghost names,
d. overwriting the true files with compressible random data, and
e. making a database entry equating the ghost location with the original true location.

11. (canceled)
